(19) United States
(12) Patent Application Publication
(10) Pub. No.: US 2023/0149907 A1
(43) Pub. Date: May 18, 2023

(54) EXHAUST GAS PURIFICATION CATALYST DEVICE

(71) Applicant: CATALER CORPORATION, Kakegawa-shi, Shizuoka (JP)

(72) Inventors: Takuto ARAKAWA, Kakegawa-shi (JP); Yuya KAWANO, Kakegawa-shi (JP); Tsubasa NANJO, Kakegawa-shi (JP); Yoshinori YAMASHITA, Kakegawa-shi (JP)

(73) Assignee: CATALER CORPORATION, Kakegawa-shi, Shizuoka (JP)

(21) Appl. No.: 17/912,151

(22) PCT Filed: Apr. 2, 2021
(86) PCT No.: PCT/JP2021/014375

§ 371 Date: Sep. 16, 2022

(30) Foreign Application Priority Data
May 26, 2020 (JP) 2020-091319

(51) Int. Cl. B01J 23/76; B01D 53/94; B01J 21/04; B01J 29/72

(52) U.S. Cl. CPC B01J 23/76; B01D 53/9418; B01J 21/04; B01J 29/723; B01D 2255/50; B01D 2255/2092; B01D 2255/20738; B01D 2255/20761; B01D 2257/402; B01D 2258/012

(57) ABSTRACT

A gas purification catalyst device comprises: a substrate; and one or more catalyst layers on the substrate. Among the one or more catalyst layers, at least one catalyst layer contains both Cu-CHA-type zeolite particles and iron-supporting metal oxide particles in which iron is supported on metal oxide particles.

### FIELD

The present invention relates to an exhaust gas purification catalytic device.

### BACKGROUND

Selective catalytic reduction (SCR) systems are known as a technology for reducing and purifying NOx in an exhaust gas emitted from an internal combustion engine such as a diesel engine before the exhaust gas is released into the atmosphere. The SCR system is a technology which uses a reductant, for example, ammonia, to reduce NOₓ in an exhaust gas to N₂.

However, in this technology, a reaction for generating nitrous oxide (N₂O) occurs and the generated N₂O is sometimes emitted from the SCR system. The generation of N₂O is considered to occur as a side reaction in the process of reducing NOₓ to N₂ by an SCR reaction or in the process of ammonia acting as a reductant.

Regulations on exhaust gas from internal combustion engines have been tightening year after year In recent years, the tightening of “GHG regulations” for regulating greenhouse gases (greenhouse effect gases) has been remarkable.

Because the contribution of N₂O as a greenhouse effect gas is significant, it is desired that N₂O emissions from internal combustion engines be as small as possible.

In this regard, PTL 1 discloses an SCR catalyst system, wherein a first catalyst composition layer comprising a mixed oxide (for example, vanadia/titania) and a second catalyst composition layer comprising a metal-exchanged zeolite (for example, a Cu-zeolite) are disposed on a substrate in this order from the upstream side of an exhaust gas flow, and describes that N₂O emissions can be decreased by this configuration.

### Citation List

### Patent Literature

[PTL 1] Japanese Unexamined PCT Publication (Kohyo) No. 2016-518244

### SUMMARY

### Technical Problem

An object of the present invention is to provide an exhaust gas purification catalytic device in which N₂O emissions (amount of N₂O slip) are greatly suppressed.

### Solution to Problem

The present invention is as follows.

«Aspect 1» An exhaust gas purification catalytic device, comprising:
a substrate and one or more catalyst layers on the substrate, wherein
of the one or more catalyst layers, at least one catalyst layer comprises both
   Cu-CHA zeolite particles, and
   iron-supporting metal oxide particles in which iron is supported on metal oxide particles.

«Aspect 2» The exhaust gas purification catalytic device according to Aspect 1, wherein the metal oxide particles are particles of one metal oxide selected from the group consisting of alumina, silica, titania, zirconia, and ceria or a composite metal oxide of two or more selected therefrom.

«Aspect 3» The exhaust gas purification catalytic device according to Aspect 2, wherein the metal oxide particles are alumina particles

«Aspect 4» The exhaust gas purification catalytic device according to any one of Aspects 1 to 3, wherein an amount of iron in the exhaust gas purification catalytic device is 0.3 g/L or more and 1.3 g/L or less as a mass of iron in terms of ferric oxide (Fe₂O₃) per L of the substrate.

«Aspect 5» The exhaust gas purification catalytic device according to any one of Aspects 1 to 3, wherein an amount of iron in the exhaust gas purification catalytic device is 0.6 g/L or more and 1.3 g/L, or less as a mass of iron in terms of ferric oxide (Fe₂O₃) per L of the substrate.

«Aspect 6» The exhaust gas purification catalytic device according to any one of Aspects 1 to 5, wherein a ratio of the Cu-CHA zeolite particles to the iron-supporting metal oxide particles in the catalyst layer, as a mass percentage of the iron-supporting metal oxide particles with respect to a total of both particles, is 5% by mass or more and 20% by mass or less.

«Aspect 7» The exhaust gas purification catalytic device according to any one of Aspects 1 to 6 for use in selective catalytic reduction.

«Aspect 8» A method for manufacturing the exhaust gas purification catalytic device according to any one of Aspects 1 to 7, comprising:
(1) mixing and wet-milling the Cu-CHA zeolite particles and the iron-supporting metal oxide particles to obtain a catalyst layer forming slurry, and
(2) applying and baking the catalyst layer forming slurry on the substrate to form the catalyst layer on the substrate

«Aspect 9» An exhaust gas purification method for purifying an exhaust gas using the exhaust gas purification catalytic device according to Aspect 7, comprising:

feeding an exhaust gas and a reductant to the exhaust gas purification catalytic device to reduce NOₓ in the exhaust gas to N₂.

### Advantageous Effects of Invention

According to the present invention, an exhaust gas purification catalytic device in which N₂O emissions (amount of N₂O slip) are greatly suppressed is provided.

### BRIEF DESCRIPTION OF DRAWINGS

FIG. 1 is an XRD chart of spray-dried iron alumina used in Example 3 (2θ = 10 to 80°).

FIG. 2 is an XRD chart of spray-dried iron alumina used in Example 3 (2θ = 29 to 35°).

FIG. 3 is an XRD chart of spray-dried iron alumina used in Example 3 (2θ = 48 to 54°).

FIG. 4 is an XRD chart of impregnated iron alumina used in Example 5 (2θ = 10 to 80°).

FIG. 5 is an XRD chart of impregnated iron alumina used in Example 5 (20 = 29 to 35°)

FIG. 6 is an XRD chart of impregnated iron alumina used in Example 5 (20 = 48 to 54°).

### DESCRIPTION OF EMBODIMENTS

The exhaust gas purification catalytic device of the present invention is
an exhaust gas purification catalytic device comprising a substrate and one or more catalyst layers on the substrate, wherein
of the one or more catalyst layers, at least one catalyst layer comprises both
   Cu-CHA zeolite particles, and
   iron-supporting metal oxide particles in which iron is supported on metal oxide particles.

The technology of PTL. 1 focuses on the fact that there are differences in the N₂ and N₂O generating capabilities between the mixed oxide and the metal-exchanged zeolite and separates the functions of the mixed oxide and the metal-exchanged zeolite so that each is used separately. The technology of PTL 1 is based on the idea of suppressing the generation of N₂O by first bringing a NOx-rich exhaust gas into contact with the first catalyst composition comprising a mixed oxide that has excellent N₂ generating capability and poor N₂O generating capability.

However, the present inventors have considered the suppression of the amount of N₂O slip, as follows.

N₂O results from, for example, a decomposition reaction of ammonium nitrate (NH₄•NO₃), an intermediate of an SCR reaction. Metal-exchanged zeolites (for example, Cu-zeolites) are considered to promote the generation of N₂O by the decomposition reaction of ammonium nitrate. On the other hand, mixed oxides (for example, iron-based materials) are considered to promote the decomposition of generated N₂O.

Therefore, it is expected that if the metal-exchanged zeolite and the mixed oxide are disposed in proximity to each other, N₂O generated by the action of the metal-exchanged zeolite is immediately decomposed, and as a result, the amount of N₂O slip can be suppressed.

In this regard, the metal-exchanged zeolite and the mixed oxide are disposed in separate layers in the SCR catalyst system disclosed in PTL 1. Thus, the degree of proximity therebetween becomes low. In such an SCR catalyst configuration, generated N₂O is not brought into contact with the mixed oxide and therefore emitted as-is without being decomposed.

In the present invention, based on the above considerations, Cu-CHA zeolite particles and iron-supporting metal oxide particles are disposed within the same catalyst layer to increase the degree of proximity therebetween, thereby achieving an exhaust gas purification catalytic device in which the amount of N₂O slip is sufficiently suppressed. Note that, the present invention is not bound by any particular theory.

Hereinafter, the components of the exhaust gas purification catalytic device of the present invention will be described in order.

### Substrate

As the substrate of the exhaust gas purification catalytic device of the present invention, a substrate generally used for exhaust gas purification catalytic devices can be used. The substrate may be, for example, a straight-flow monolithic honeycomb substrate composed of a material such as cordierite, SiC, stainless steel, or inorganic oxide particles.

### Catalyst Layer

The exhaust gas purification catalytic device of the present invention includes one or more catalyst layers, and one catalyst layer thereof comprises both Cu-CHA zeolite particles and iron-supporting metal oxide particles. Specifically, in the exhaust gas purification catalytic device of the present invention, the Cu-CHA zeolite particles and the iron-supporting metal oxide particles are contained within the same catalyst layer.

As used herein, a catalyst layer comprising both Cu-CHA zeolite particles and iron-supporting metal oxide particles is referred to as a “specific catalyst layer”.

### Cu-CHA Zeolite Particles

The Cu-CHA zeolite particles of the present invention refer to particles consisting of CHA (chabazite) zeolite ion-exchanged with copper. As the Cu-CHA zeolite particles, those publicly known as an SCR catalyst may be appropriately selected and used.

The Cu-CHA zeolite particles, from the viewpoint of ensuring high SCR catalytic activity, may have an SAR (silica-alumina ratio, SiO₂/A1₂O₃ molar ratio) of 20 or less, 18 or less, 15 or less, 12 or less, 10 or less, 9 or less, or 8 or less.

When the SAR of the Cu-CHA zeolite particles is excessively low, the specific surface area of the zeolite decreases and the NOₓ purification capability may be impaired. From the viewpoint of avoiding this, the SAR of the Cu-CHA zeolite particles may be 3 or greater, 4 or greater, 5 or greater, 6 or greater, or 7 or greater.

The Cu in the Cu-CHA zeolite particles is considered to be supported on surface Al sites of the CHA zeolite and constitute catalytically active sites for NOₓ purification in the SCR catalyst. The amount of Cu in the Cu-CHA zeolite as a molar ratio (Cu/Al) of Cu to Al, from the viewpoint of exhibiting high NOₓ purification capability, may be 0.05 or greater, 0.10 or greater, 0.15 or greater, 0.20 or greater, or 0.25 or greater, and from the viewpoint of maintaining stable NOₓ purification capability, may be 1.00 or less, 0.80 or less, 0.60 or less, 0.50 or less, 0.45 or less, 0.40 or less, 0.35 or less, 0.30 or less, or 0.25 or less.

The Cu-CHA zeolite particles of the present invention may comprise an alkali metal. In a Cu-CHA zeolite particles comprising a proper amount of alkali metal, high initial NOx purification capability is maintained while hydrothermal durability is further improved. However, when the amount of alkali metal contained in the Cu-CHA zeolite particles is excessively large, the initial NOₓ purification capability may be impaired.

From these viewpoints, the amount of alkali metal in the Cu-CHA zeolite particles, as a ratio of the converted mass of M₂O (wherein M indicates an alkali metal) to the total mass of the Cu-CHA zeolite, may be 0.2% by mass or greater, 0.3% by mass or greater, 0.4% by mass or greater, 0.5% by mass or greater, 0.6% by mass or greater, 0.7% by mass or greater, or 0.8% by mass or greater and may be 2.0% by mass or less, 1.8% by mass or less, 1.6% by mass or less, 1.4% by mass or less, 1.2% by mass or less, 1.0% by mass or less, 0.9% by mass or less, or 0.8% by mass or less.

The alkali metal contained in the Cu-CHA zeolite particles may be lithium (Li), sodium (Na), potassium (K), or cesium (Cs), and may typically be potassium.

The primary particle size of the Cu-CHA zeolite particles may be 0.1 µm or more, 0.2 µm or more, 0.3 µm or more, or 0.4 µm or more and may be 1.0 µm or less, 0.8 µm or less, 0.6 µm or less, 0.5 µm or less, or 0.4 µm or less.

The amount of Cu-CHA zeolite particles in the exhaust gas purification catalytic device of the present invention as a mass of the Cu-CHA zeolite per L of substrate, from the viewpoint of ensuring sufficiently high SCR catalytic activity, may be 70 g/L or more, 80 g/L or more, 100 g/L or more, 120 g/L or more, 130 g/L or more, or 140 g/L or more, and from the viewpoint of suppressing pressure loss in the exhaust gas purification catalytic device, may be 200 g/L, or less, 180 g/L or less, 160 g/L or less, 150 g/L or less, or 140 g/L or less.

### Iron-Supporting Metal Oxide Particles

The iron-supporting metal oxide particles of the present invention are particles consisting of iron supported on metal oxide particles

The metal oxide particles may be particles of one metal oxide selected from alumina, silica, titania, zirconia, and ceria or a composite metal oxide of two or more selected therefrom. The metal oxide particles are typically alumina particles.

The amount of iron supported on the iron-supporting metal oxide particles with respect to the total mass of the iron-supporting metal oxide particles, from the viewpoint of sufficiently suppressing the amount of N₂O slip, as a ratio of the mass of iron in terms of ferric oxide (Fe₂O₃) may be 0.5% by mass or greater, 1% by mass or greater, 3% by mass or greater, 5% by mass or greater, 6% by mass or greater, or 7% by mass or greater. When the amount of iron supported is 20% by mass or less, 15% by mass or less, 12% by mass or less, or 10% by mass or less, a sufficiently high suppressing effect on the amount of N₂O slip is obtained.

The iron (for example, ferric oxide) on the iron-supporting metal oxide particles may be in particle form, and may have a particle size of about 1 nm or more and 50 nm or less.

Such iron-supporting metal oxide particles may be prepared, for example, using desired metal oxide particles by an appropriate method, such as a spray drying method or an impregnation method

The manufacture of the iron-supporting metal oxide particles by a spray drying method may be carried out, for example, by a method comprising the following steps:
mixing a sol of the desired metal oxide particles and an iron compound in a suitable solvent (for example, water) to prepare a mixed solution;
spray-drying the obtained mixed solution to obtain a precursor particle gel in a dried powder form; and
baking the obtained precursor particle gel.

The manufacture of the iron-supporting metal oxide particles by an impregnation method may be carried out, for example, by a method comprising the following steps:
immersing the desired metal oxide particles in a solution obtained by dissolving an iron compound in an appropriate solvent (for example, water); and
baking the metal oxide particles after immersion.

The iron compound used in a spray drying method or an impregnation method may be an iron compound soluble in a solvent or a water-soluble iron compound. Specifically, the iron compound may be, for example, iron sulfate, iron nitrate, iron chloride, or potassium hexacyanoferrate.

The primary particle size of the iron-supporting metal oxide particles may be 0.01 µm or more, 0.03 µm or more, or 0.05 µm or more and may be 1 µm or less, 0.5 µm or less, or 0.2 µm or less.

In the iron-supporting metal oxide particles, it is desirable that the iron supported on the metal oxide particles be as highly dispersed as possible. Specifically, the iron may be highly dispersed to such an extent that crystal peaks attributed to ferric oxide (Fe₂O₃) are not observed in XRD measured for a milled product of the iron-supporting metal oxide particles. In the XRD measurement, the crystal peaks of ferric oxide are generally observed in the vicinity of 2θ = 31° and 51°.

The amount of iron-supporting metal oxide particles in the exhaust gas purification catalytic device of the present invention as a mass of the iron-supporting metal oxide per L of substrate, from the viewpoint of sufficiently increasing the suppressing effect on the amount of N₂O slip, may be 1 g/L or more, 3 g/L or more, 5 g/L or more, 10 g/L or more, or 12 g/L or more, and from the viewpoint of suppressing pressure loss in the exhaust gas purification catalytic device, may be 30 g/L or less, 25 g/L, or less, 20 g/L or less, 18 g/L or less, or 15 g/L or less.

From the same viewpoints, the amount of iron in the exhaust gas purification catalytic device as a mass of iron in terms of ferric oxide (Fe₂O₃) per L of the substrate may be 0.3 g/L or more, 0.5 g/L or more, 1.7 g/L or more, or 1.0 g/L or more and may be 1.3 g/L or less, 1.2 g/L or less, 1.1 g/L, or less, or 1.0 g/L or less.

### Ratio of Cu-CHA Zeolite Particles to Iron-Supporting Metal Oxide Particles

In the exhaust gas purification catalytic device of the present invention, the ratio of Cu-CHA zeolite particles to iron-supporting metal oxide particles in the specific catalyst layer, from the viewpoint of balancing the SCR catalytic activity and the suppressing effect on the amount of N₂O slip, as a mass ratio (mass percentage) of iron-supporting metal oxide with respect to the total mass of the Cu-CHA zeolite and the iron-supporting metal oxide may be 5% by mass or greater, 7% by mass or greater, 10% by mass or greater, 12% by mass or greater, or 15% by mass or greater and may be 20% by mass or less, 18% by mass or less, 15% by mass or less, or 12% by mass or less.

### Optional Component of Specific Catalyst Layer

The specific catalyst layer of the exhaust gas purification catalytic device of the present invention comprises both Cu-CHA zeolite particles and iron-supporting metal oxide particles. The specific catalyst layer may comprise an additionally optional component.

The additional component contained in the specific catalyst layer may be, for example, a different type of metal oxide particles other than the Cu-CHA zeolite particles and the iron-supporting metal oxide particles, or a binder.

The different type of metal oxide particles may be particles of one metal oxide selected from, for example, alumina, silica, titania, zirconia, and ceria or a composite metal oxide of two or more selected therefrom. The binder may be a bake-hardened product of a metal oxide sol such as alumina sol, silica sol, titania sol, or zirconia sol.

### Amount of Specific Catalyst Layer

The amount (coating amount) of the specific catalyst layer of the exhaust gas purification catalytic device of the present invention as a mass of the specific catalyst layer per L of substrate, from the viewpoint of exhibiting sufficiently high SCR catalytic activity, may be 80 g/L or more, 100 g/L or more, 120 g/L or more, 130 g/L or more, or 140 g/L or more, and from the viewpoint of suppressing pressure loss in the exhaust gas purification catalytic device, may be 250 g/L or less, 200 g/L or less, 180 g/L or less, 160 g/L, or less, 150 g/L or less, or 140 g/L or less.

### Additional Catalyst Layer

The exhaust gas purification catalytic device of the present invention includes a specific catalyst layer. The exhaust gas purification catalytic device of the present invention may include an additional catalyst layer other than the specific catalyst layer, as needed.

The additional catalyst layer of the exhaust gas purification catalytic device of the present invention may be, for example, a catalyst layer exhibiting NOx oxidation capability or a catalyst layer exhibiting ASC (ammonia slip catalyst) capability. These may be configured in the same manner as in publicly known catalyst layers. Further, in the exhaust gas purification catalytic device of the present invention, the specific catalyst layer and the additional catalyst layer may be laminated on a substrate in any order. Alternatively, the catalyst layers may be present on a substrate in any order as catalyst layers on the upstream and downstream sides of an exhaust gas flow direction.

### Method for Manufacturing Exhaust Gas Purification Catalytic Device

The exhaust gas purification catalytic device of the present invention may be manufactured by any method as long as the catalytic device has the above configuration. Using the embodiment in which the specific catalyst layer is included in a single layer on a substrate as an example of the exhaust gas purification catalytic device of the present invention, the following method is exemplified as a method for manufacturing the catalytic device: a method for manufacturing an exhaust gas purification catalytic device, comprising:
(1) mixing and wet-milling a Cu-CHA zeolite and iron-supporting metal oxide particles to obtain a catalyst layer forming slurry (catalyst layer forming slurry preparation step), and
(2) applying and baking the catalyst layer forming slurry on a substrate to form the catalyst layer on the substrate (catalyst layer formation step).

In the catalyst layer forming slurry preparation step, predetermined Cu-CHA zeolite particles of the present invention and predetermined iron-supporting metal oxide particles of the present invention are mixed in a predetermined ratio and wet-milled to obtain a catalyst layer forming slurry (specific catalyst layer formation step).

The milling in the catalyst layer forming slurry preparation step, from the viewpoints of uniformizing the particle size of each particle, stabilizing catalytic activity, and suppressing occurrence of crystal defects particularly in the Cu-CHA zeolite particles, is carried out by wet-milling in a suitable liquid medium (for example, water)

Wet milling may be carried out, for example, using a suitable liquid medium and an appropriate milling apparatus, such as a ball mill, a bead mill, a jet mill, or an air jet mill.

In the catalyst layer formation step, a catalyst layer forming slurry is applied and baked on a substrate to form a catalyst layer on the substrate.

The substrate may be appropriately selected according to the substrate of the desired exhaust gas purification catalytic device. For example, the substrate may be a straight-flow monolithic honeycomb substrate made of cordierite.

The application and the baking of the catalyst layer forming slurry on a substrate may each be carried out by a publicly known method or a method obtained from a publicly known method appropriately modified by a person skilled in the art. The baking temperature may be, for example, 300° C. or higher, 350° C. or higher, 400° C. or higher, 450° C. or higher, or 500° C. or higher and may be, for example, 1,000° C. or lower, 800° C. or lower, 700° C. or lower, 600° C. or lower, 550° C. or lower, or 500° C. or lower.

### Application of Exhaust Gas Purification Catalytic Device

The exhaust gas purification catalytic device of the present invention may be used as a catalytic device for selective catalytic reduction (SCR), for purifying an exhaust gas emitted from, for example, a diesel internal combustion engine or a gasoline internal combustion engine.

The exhaust gas purification catalytic device of the present invention may be combined with one or more selected from a DPF (diesel particulate filter) device, a GPF (gasoline particulate filter) device, or an ASC (ammonia slip catalyst) device and used as a part of an exhaust gas purification catalytic system.

### Exhaust Gas Purification Method

The present invention further provides an exhaust gas purification method for purifying an exhaust gas using the exhaust gas purification catalytic device of the present invention.

The exhaust gas purification method of the present invention is a method comprising feeding an exhaust gas and a reductant to the exhaust gas purification catalytic device to reduce NOₓ in the exhaust gas to N₂.

The reductant of the exhaust gas purification method of the present invention may be, for example, ammonia, ammonia water, urea, a hydrocarbon, or an atomized fuel. Since the exhaust gas purification catalytic device of the present invention greatly suppresses the generation of N₂O from ammonia (NH₃) used as a reductant in an SCR reaction, one or more particularly selected from ammonia, ammonia water, and urea may be used as the reductant

### EXAMPLES

In the following Examples, honeycomb substrates made of cordierite, having a cell density of 400 cpsi (cells per square inch), a wall thickness of 6 mil (0.15 mm), and a capacity of 35 mL, were used as substrates.

Particles having a silica/alumina molar ratio (SAR) of 7.5 and a Cu-to-Al molar ratio (Cu/Al) of 0.25 were used as Cu-CHA zeolite particles.

### Example 1

### Preparation of Catalyst Layer Forming Slurry

Into 200 parts by mass of pure water, 100 parts by mass (dry mass of 15 parts by mass) of a silica binder sol dispersion liquid, 85 parts by mass of Cu-CHA zeolite particles, and 2 parts by mass of iron alumina particles (spray-dried alumina particles, amount of Fe₂O₃ supported at 9.0% by mass) as iron-supporting metal oxide particles were mixed in this order and milled by a wet milling method, whereby a catalyst layer forming slurry was obtained.

### Manufacture of Exhaust Gas Purification Catalytic Device

The catalyst layer forming slurry obtained above was applied onto a substrate so that the coating amount after baking was 142.8 g/L, dried at 250° C., and then baked at 500° C. for 1 h, whereby a catalyst layer was formed on the substrate to manufacture an exhaust gas purification catalytic device. The coating amount of the additive (iron alumina particles) of the catalyst layer on the exhaust gas purification catalytic device was 2.8 g/L. Subsequently, the exhaust gas purification catalytic device endured 50 h in a hydrothermal endurance furnace at 630° C. and was then subjected to evaluation of SCR performance.

### Evaluation of SCR Performance

The SCR performance of the exhaust gas purification catalytic device obtained above was evaluated using a model gas.

The exhaust gas purification catalytic device was first heated to elevate the temperature from room temperature to 600° C. at a temperature elevation rate of 25° C./min while a gas having the composition of gas condition 1 shown in Table 1 below was flowed at a space velocity (SV) of 60,000 h⁻¹. Immediately after the temperature of the device reached 600° C., heating was stopped and the device was allowed to cool. After the device temperature decreased to 500° C., the temperature was maintained while a gas having the composition of gas condition 2 shown in Table 2 below was flowed at a space velocity (SV) of 60,000 h⁻¹. The composition of the resulting exhaust gas was examined, and the NOₓ purification rate and the amount of N₂O slip were calculated. The results are shown in Table 3. [Table 1]

TABLE 1

Gas condition 1

| | |
|---|---|
| Gas type | Concentration |
| NO | 0 ppm |
| NH₃ | 0 ppm |
| O₂ | 10 vol% |
| H₂O | 0 vol% |
| CO₂ | 0 vol% |
| N2 | Balance |

Space velocity 60,000 h⁻¹

TABLE 2

Gas condition 2

| | |
|---|---|
| Gas type | Concentration |
| NO | 500 ppm |
| NH₃ | 500 ppm |
| O₂ | 10 vol% |
| H₂O | 5 vol% |
| CO₂ | 8 vol% |
| N2 | Balance |

Space velocity 60,000 h⁻¹

### Examples 2 to 4 and Comparative Examples 1 and 2

Except that the amounts of Fe₂O₃ supported on the spray-dried iron alumina particles were changed as shown in Table 3, catalyst layer forming slurries were each prepared in the same manner as in Example 1. Except that the application amounts were changed so that the coating amounts after baking were as indicated in Table 3, the catalyst layer forming slurries were each applied onto a substrate and subjected to drying and baking in the same manner as in Example 1 to manufacture an exhaust gas purifying catalytic device.

In Comparative Example 2, the amount of pure water used when preparing the catalyst layer forming slurry was set to 250 parts by mass.

The obtained exhaust gas purification catalytic devices were evaluated for endurance and SCR performance in the same manner as in Example 1. The results are shown in Table 3.

### Example 5

Except that impregnated iron alumina particles in which the same amount of Fe₂O₃ was supported on alumina by an impregnation method were used in place of spray-dried iron alumina particles, an exhaust gas purification catalytic device was manufactured in the same manner as in Example 3 and evaluated. The results are shown in Table 3.

### Comparative Example 3

Except that a mixture of 9.1 parts by mass of alumina and 0.9 parts by mass of iron oxide was used in place of spray-dried iron alumina particles, an exhaust gas purification catalytic device was manufactured in the same manner as in Example 3 and evaluated. The results are shown in Table 3.

TABLE 3

Relationship between iron-supporting metal oxide particle amount and SCR performance

| | Catalyst layer configuration | Catalyst layer forming slurry | | | | | | Catalyst layer | | | | SCR performance | |
|---|---|---|---|---|---|---|---|---|---|---|---|---|---|
| | | Binder sol | | Cu-CHA zeolite particle | Iron-supporting metal oxide particle | | | Catalyst layer coating amount | Iron-supporting metal oxide particle | | Iron amount (g/L in terms of Fe₂O₃) | NOx purification rate (500° C.) (%) | N₂O slip (500° C.) (ppm) |
| | | Type | Amount (parts by mass) | Amount (parts by mass) | Type | Amount of Fe₂O₃ supported (% by mass) | Amount (parts by mass) | | Amount (g/L) | Ratio in coating layer (% by mass) | | | |
| Comparative Example 1 | Single -layer | Silica | 15 | 85 | - | - | - | 140.0 | - | 0.0 | 0.0 | 88.12 | 16.07 |
| Example 1 | Single -layer | Silica | 15 | 85 | Spray-dried iron alumina | 9.0 | 2 | 142.8 | 2.8 | 2.0 | 0.3 | 89.30 | 10.46 |
| Example 2 | Single -layer | Silica | 15 | 85 | Spray-dried iron alumina | 9.0 | 5 | 147.0 | 7.0 | 4.8 | 0.6 | 89.10 | 8.43 |
| Example 3 | Single -layer | Silica | 15 | 85 | Spray-dried iron alumina | 9.0 | 10 | 154.0 | 14.0 | 9.1 | 1.3 | 90.20 | 8.19 |
| Example 4 | Single -layer | Silica | 15 | 85 | Spray-dried iron alumina | 9.0 | 20 | 168.0 | 28.0 | 16.7 | 2.5 | 87.52 | 8.01 |
| Example 5 | Single -layer | Silica | 15 | 85 | Impregnated iron alumina | 9.0 | 10 | 154.0 | 14.0 | 9.1 | 1.3 | 88.42 | 9.48 |
| Comparative Example 2 | Single -layer | Alumina | 5 | - | Spray-dried iron alumina | 9.0 | 95 | 14.7 | 14.0 | 95.2 | 1.3 | -3.10 | 0.00 |
| Comparative Example 3 | Single -layer | Silica | 15 | 85 | Alumina | - | 9.1 | 154.0 | 14.0 | 9.1 | 1.3 | 88.14 | 12.23 |
| | | | | | Iron oxide | - | 0.9 | | | | | | |

In the evaluation of the exhaust gas purification catalytic device of the present invention, a larger value of NOx purification rate is more satisfactory, and a smaller value of the amount of N₂O slip is more satisfactory.

With reference to Table 3, the amount of N₂O slip was suppressed in each of Examples 1 to 4 comprising iron-supporting metal oxide particles, compared to that of Comparative Example 1 not comprising any iron-supporting metal oxide particles. Further, it was found that the amount of N₂O slip tends to decrease as the ratio of iron-supporting metal oxide particles in the coating layer increases. However, when the ratio of iron-supporting metal oxide particles in the coating layer exceeded 2.0% by mass and reached about 4.8% by mass or greater, the tendency for the amount of N₂O slip to decrease moderated.

From the foregoing, the ratio of iron-supporting metal oxide particles in the coating layer, from the viewpoint of suppressing the amount of N₂O slip, may be 2.0% by mass or greater, 3.0% by mass or greater, 4.0% by mass or greater, or 4.5% by mass or greater, and from the viewpoint of effectiveness in blending, may be 20% by mass or less, 18% by mass or less, or 16% by mass or less.

When the amount of iron in an exhaust gas purification catalytic device (mass of iron in terms of ferric oxide (Fe₂O₃) per L of substrate) was in the range of 0.3 g/L or more and 2.5 g/L or less, the amount of N₂O slip was suppressed and satisfactory results were obtained, compared to those of the Comparative Examples. Further, when the amount of iron in the exhaust gas purification catalytic device was in the range of 0.6 g/L or more and 2.5 g/L or less, the NOx purification capability was excellent compared to those of the Comparative Examples.

In Comparative Example 2 not comprising any Cu-CHA zeolite, the apparent amount of N₂O slip was 0.00 since the catalyst layer did not have any NOx decomposition capability. Further, an oxidation reaction of NH₃ occurred in the catalytic device of Comparative Example 2. Thus, the NOx purification rate showed a negative value in calculation.

### Examples 6 and 7

Except that the amounts of Fe₂O₃ supported on iron alumina particles were changed as shown in Table 4, catalyst layer forming slurries were each prepared in the same manner as in Example 3 and used to manufacture an exhaust gas purification catalytic device.

The obtained exhaust gas purification catalytic devices were evaluated for endurance and SCR performance in the same manner as in Example 1. The results, as well as the evaluation results for Comparative Example 1 and Example 3, are shown in Table 4.

TABLE 4

Relationship between amount of iron supported on iron-supporting metal oxide particle and SCR performance

| | Catalyst layer configuration | Catalyst layer forming slurry | | | | | | Catalyst layer | | | | SCR performance | |
|---|---|---|---|---|---|---|---|---|---|---|---|---|---|
| | | Binder sol | | Cu-CHA zeolite particle | Iron-supporting metal oxide particle | | | Catalyst layer coating amount (g/L) | Iron-supporting metal oxide particle | | Iron amount (g/L in terms of Fe₂O₃) | NOx purification rate (500° C.) (%) | N₂O slip (500° C.) (ppm) |
| | | Amount Type (parts by mass) | | Amount (parts by mass) | TypeI | Amount of Fe₂O₃ supported (% by mass) | Amount (parts by mass) | | Amount (g/L) | Ratio in coating layer (% by mass) | | | |
| Comparative Example 1 | Single-layer | Silica | 15 | 85 | - | - | - | 140.0 | - | 0.0 | 0.0 | 88.12 | 16.07 |
| Example 6 | Single-layer | Silica | 15 | 85 | Spray-dried iron alumina | 2.0 | 10 | 154.0 | 14.0 | 9.1 | 0.3 | 89.10 | 12.29 |
| Example 7 | Single-layer | Silica | 15 | 85 | Spray-dried iron alumina | 5.0 | 10 | 154.0 | 14.0 | 9.1 | 0.7 | 88.90 | 7.59 |
| Example 3 | Single-layer | Silica | 15 | 85 | Spray-dried iron alumina | 9.0 | 10 | 154.0 | 14.0 | 9.1 | 1.3 | 90.20 | 8.19 |

With reference to Table 4, the amount of N₂O slip was suppressed in each of Examples 3, 6, and 7 comprising iron-supporting metal oxide particles, compared to that of Comparative Example 1 not comprising any iron-supporting metal oxide particles. Further, it was found that the amount of N₂O slip tends to decrease as the ratio of Fe₂O₃ supported in the iron-supporting metal oxide particles increases. From the foregoing, it was confirmed that as long as the ratio of Fe₂O₃ supported in the iron-supporting metal oxide particles is 2.0% by mass or greater, a suppressing effect on the amount of N₂O slip can be exhibited, and if the ratio is 3.0% by mass or greater, 4.0% by mass or greater, or 5.0% by mass or greater, the suppressing effect on the amount of N₂O slip is suitably exhibited

### Examples 8 to 11

Except that different types of iron-supporting metal oxide particles (amount of Fe₂O₃ supported at 9.0% by mass) shown in Table 5 were each used in place of iron alumina particles, catalyst layer forming slurries were each prepared in the same manner as in Example 3 and used to manufacture an exhaust gas purification catalytic device.

The obtained exhaust gas purification catalytic devices were evaluated for endurance and SCR performance in the same manner as in Example 1. The results, as well as evaluation results for Comparative Example 1 and Example 3, are shown in Table 5.

TABLE 5

Relationship between metal oxide type of iron-supporting metal oxide particle and SCR performance

| | Catalyst layer configuration | Catalyst layer forming slurry | | | | | | Catalyst layer | | | | SCR performance | |
|---|---|---|---|---|---|---|---|---|---|---|---|---|---|
| | | Binder sol | | Cu-CHA zeolite particle | Iron-supporting metal oxide particle | | | Catalyst layer coating amount (g/L) | Iron-supporting metal oxide particle | | Iron amount (g/L in terms of Fe₂O₃) | NOx purification rate (500° C.) (%) | N₂O slip (500° C.) (ppm) |
| | | Type | Amount (parts by mass) | Amount (parts by mass) | Type | Amount of Fe₂O₃ supported (% by mass) | Amount (parts by mass) | | Amount (g/L) | Ratio in coating layer (% by mass) | | | |
| Comparative Example 1 | Single-layer | Silica | 15 | 85 | - | - | - | 140.0 | - | 0.0 | 0.0 | 88.12 | 16.07 |
| Example 3 | Single-layer | Silica | 15 | 85 | Spray-dried iron alumina | 9.0 | 10 | 154.0 | 14.0 | 9.1 | 1.3 | 90.20 | 8.19 |
| Example 8 | Single-layer | Silica | 15 | 85 | Spray-dried iron silica-alumina | 9.0 | 10 | 154.0 | 14.0 | 9.1 | 1.3 | 89.21 | 8.53 |
| Example 9 | Single-layer | Silica | 15 | 85 | Spray-dried iron titania | 9.0 | 10 | 154.0 | 14.0 | 9.1 | 1.3 | 90.31 | 7.97 |
| Example 10 | Single-layer | Silica | 15 | 85 | Spray-dried iron zirconia | 9.0 | 10 | 154.0 | 14.0 | 9.1 | 1.3 | 88.82 | 8.53 |
| Example 11 | Single-layer | Silica | 15 | 85 | Spray-dried iron ceria | 9.0 | 10 | 154.0 | 14.0 | 9.1 | 1.3 | 89.69 | 9.57 |

The abbreviations in the iron-supporting metal oxide particle column in Table 5 have the following respective meanings.
Spray-dried iron alumina: particle in which iron oxide (Fe₂O₃) is supported on γ-alumina, manufactured by a spray drying method
Spray-dried iron silica-alumina: particle in which iron oxide (Fe₂O₃) is supported on silica-alumina (SiO₂:Al₂O₃ = 5:95 (mass ratio)), manufactured by a spray drying method
Spray-dried iron titania: particle in which iron oxide (Fe₂O₃) is supported on titania, manufactured by a spray drying method
Spray-dried iron ceria: particle in which iron oxide (Fe₂O₃) is supported on ceria, manufactured by a spray drying method

From the results in Table 5, it was confirmed that in addition to alumina, the expected effect of the present invention was exhibited even when silica-alumina, titania, or ceria was used as a carrier of the iron-supporting metal oxide particles.

### Comparative Example 4

### Preparation of Catalyst Layer Forming Slurry 1

Into 250 parts by mass of pure water, 5 parts by mass of an alumina binder sol and 95 parts by mass of iron alumina (Fe₂O₃ content at 9.0% by mass) particles as iron-supporting metal oxide particles were mixed in this order and milled by a wet milling method, whereby a catalyst layer forming slurry 1 was obtained

### Preparation of Catalyst Layer Forming Slurry 2

Into 200 parts by mass of pure water, 100 parts by mass (dry mass of 15 parts by mass) of a silica binder sol dispersion liquid and 85 parts by mass of Cu-CHA zeolite particles were mixed in this order and milled by a wet milling method, whereby a catalyst layer forming slurry 2 was obtained.

### Manufacture of Exhaust Gas Purification Catalytic Device

The catalyst layer forming slurry 1 was applied onto a substrate so that the coating amount after baking was 14 g/L and dried at 250° C. Subsequently, the catalyst layer forming slurry 2 was applied onto the substrate having the catalyst layer forming slurry 1 applied and dried thereon so that the coating amount after baking was 140 g/L, dried at 250° C., and then baked at 500° C. for 1 h, whereby a catalyst layer consisting of a lower layer comprising iron-supporting metal oxide particles and an upper layer comprising Cu-CHA zeolite particles was formed on the substrate to manufacture an exhaust gas purification catalytic device.

### Evaluation of SCR Performance

The exhaust gas purification catalytic device obtained above was evaluated for SCR performance in the same manner as in Example 1. The results are shown in Table 6.

### Comparative Example 5

Using the catalyst layer forming slurry 1 and catalyst layer forming slurry 2 prepared in the same manner as in Comparative Example 4, except that the application order was reversed, a catalyst layer consisting of a lower layer (coating amount of 140 g/L) comprising Cu-CHA zeolite particles and an upper layer (coating amount of 14 g/L) comprising iron-supporting metal oxide particles was formed on the substrate in the same manner as in Comparative Example 3 to manufacture an exhaust gas purification catalytic device. The obtained exhaust gas purification catalytic device was evaluated for SCR performance in the same manner as in Example 1. The results are shown in Table 6.

### Comparative Example 6

An exhaust gas purification catalytic device obtained in the same manner as in Comparative Example 1 was disposed on the upstream side of an exhaust gas flow and
an exhaust gas purification catalytic device obtained in the same manner as in Comparative Example 2 was disposed on the downstream side of the exhaust gas flow, and these catalytic devices were connected in series to form a tandem exhaust gas purification catalytic system. The obtained exhaust gas purification catalytic system was evaluated for SCR performance in the same manner as in Example 1. The results are shown in Table 6.

### Comparative Example 7

An exhaust gas purification catalytic device obtained in the same manner as in Comparative Example 2 was disposed on the upstream side of an exhaust gas flow and
an exhaust gas purification catalytic device obtained in the same manner as in Comparative Example 1 was disposed on the downstream side of the exhaust gas flow, and these catalytic devices were connected in series to form a tandem exhaust gas purification catalytic system. The obtained exhaust gas purification catalytic system was evaluated for SCR performance in the same manner as in Example 1. The results are shown in Table 6.

TABLE 6

Relationship between layer configuration of exhaust gas purification catalytic device and SCR performance

| | Catalyst layer configuration | | Catalyst layer forming slurry | | | | | | Catalyst layer | | | | SCR performance | |
|---|---|---|---|---|---|---|---|---|---|---|---|---|---|---|
| | | | Binder sol | | Cu-CHA zeolite particle | Iron-supporting metal oxide particle | | | Catalyst layer coating amount (g/L) | Iron-supporting metal oxide particle | | Iron amount (g/L in terms of Fe₂O₃) | NOx purification rate (500°C) (%) | N₂O slip (500°C) (ppm) |
| | | | Type | Amount (parts by mass) | Amount (pans by mass) | Type | Amount of Fe₂O₃ supported (% by mass) | Amount (parts by mass) | | Amount (g/L) | Ratio in coating layer (% by mass) | | | |
| Example 3 | Single-layer | | Silica | 15 | 85 | Spray-dried iron alumina | 9.0 | 10 | 154.0 | 14.0 | 9.1 | 1.3 | 90.20 | 8.19 |
| Comparative Example 4 | Two-layer | Upper laye r | Silica | 15 | 85 | - | - | - | 140.0 | - | 0.0 | 0.0 | 90.01 | 10.24 |
| | | Lower layer | Alumina | 5 | - | Spray-dried iron alumina | 9.0 | 95 | 14.7 | 14.0 | 95.2 | 1.3 | | |
| Comparative Example 5 | T Two-layer | Upper layer | Alumina | 5 | - | Spray-dried iron alumina | 9.0 | 95 | 14.7 | 14.0 | 95.2 | 1.3 | 88.60 | 9.75 |
| | | Lower layer | Silica | 15 | 85 | - | - | - | 140.0 | - | 0.0 | 0.0 | | |
| Comparative Example 6 | Tandem | Upstream side | Silica | 15 | 85 | - | - | - | 140.0 | - | 0.0 | 0.0 | 90.23 | 11.32 |
| | | Downstream side | Alumina | 5 | - | Spray-dried iron alumina | 9.0 | 95 | 14.7 | 14.0 | 95.2 | 1.3 | | |
| Comparative Example 7 | Tandem | Upstream side | Alumina | 5 | - | Spray-dried iron alumina | 9.0 | 95 | 14.7 | 14.0 | 95.2 | 1.3 | 87.90 | 12.29 |
| | | Downstream side | Silica | 15 | 85 | - | - | - | 140.0 | - | 0.0 | 0.0 | | |

Example 3 relates to an example of the catalytic device of the present invention that includes a single-layer catalyst coating layer in which Cu-CHA zeolite particles and iron-supporting metal oxide particles are mixed. In the catalyst coating layer of the catalytic device of Example 3, the Cu-CHA zeolite particles and the iron-supporting metal oxide particles were mixed in the same catalyst coating layer, and the contact frequency therebetween is considered to be high. In Example 3, the amount of N₂O slip was extremely small.

Comparative Examples 4 and 5 each relate to a catalytic device having a two-layer catalyst coating layer in which a layer comprising Cu-CHA zeolite particles and a layer comprising iron-supporting metal oxide particles are laminated. In the catalyst coating layer of each of these Comparative Examples, the Cu-CHA zeolite particles and the iron-supporting metal oxide particles were brought into contact only at the contact interface between the two layers. Compared to Example 3, the suppression of the amount of N₂O slip in Comparative Examples 4 and 5 was insufficient.

Comparative Examples 6 and 7 each relate to a tandem catalytic system in which a catalytic device including a catalyst coating layer comprising Cu-CHA zeolite particles and a catalytic device including a catalyst coating layer comprising iron-supporting metal oxide particles are connected in series. In the catalyst coating layer of each of these Comparative Examples, the Cu-CHA zeolite particles and the iron-supporting metal oxide particles were not brought into contact with each other. Compared to Comparative Examples 4 and 5, the amount of N₂O slip in each of Comparative Examples 6 and 7 was even larger.

As described above, it was found that the suppressing effect on the amount of N₂O slip was improved in the order of the tandem-type Comparative Examples 6 and 7, Comparative Examples 4 and 5 having the two-layer configuration, and Example 3 having the single-layer configuration. From the foregoing, it was found that from the viewpoint of suppressing the amount of N₂O slip, it is desirable to dispose the Cu-CHA zeolite particles and the iron-supporting metal oxide particles in the same catalyst layer to increase the contact frequency therebetween.

### Analysis Example 1

The spray-dried iron alumina particles used in the above Example 3 were milled, and the XRD therefor was measured. Peaks from Fe₂O₃ crystals were not observed in the vicinity of 20 = 31° and 51°, confirming that Fe₂O₃ was supported on alumina with extremely high dispersion

The XRD measurement conditions were as follows.
XRD measurement apparatus: powder/thin film X-ray diffractometer, model name “RINT TTR III”, manufactured by Rigaku Corporation
Measurement method: step scanning method
Feed rate: 4°/min
Diffraction angle range: 20 = 5 to 85°
Step width: 0.02°
Acceleration voltage: 40 kV
Acceleration current: 250 mA

### Analysis Example 2

The impregnated iron alumina used in the above Example 5 was milled, and the XRD therefor was measured in the same manner as in Analysis Example 1. In the vicinity of 2θ = 31° and 51° were observed peaks which were both attributed to Fe₂O₃ crystals, indicating that Fe₂O₃ aggregated on alumina to form a crystal phase. The peak in the vicinity of 2θ = 31° is a shoulder peak

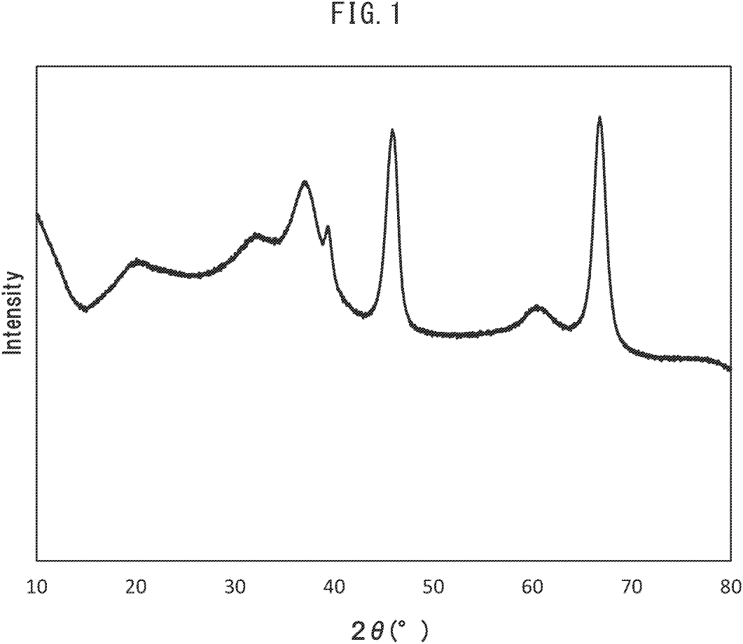

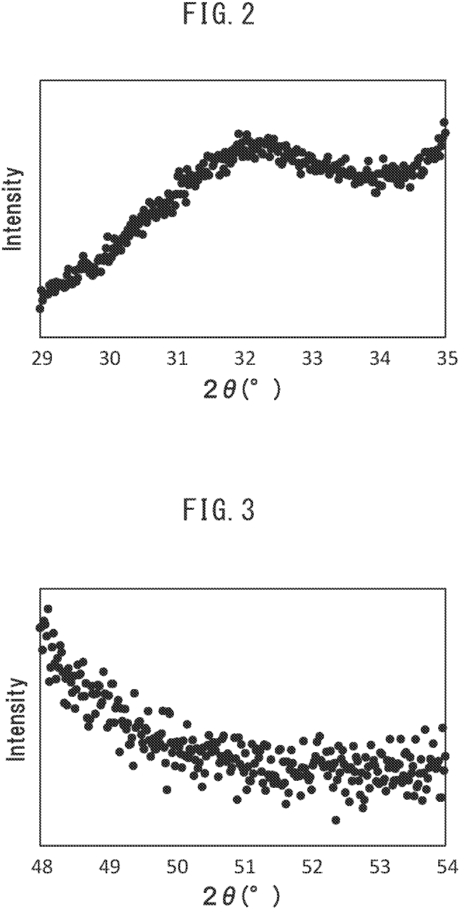

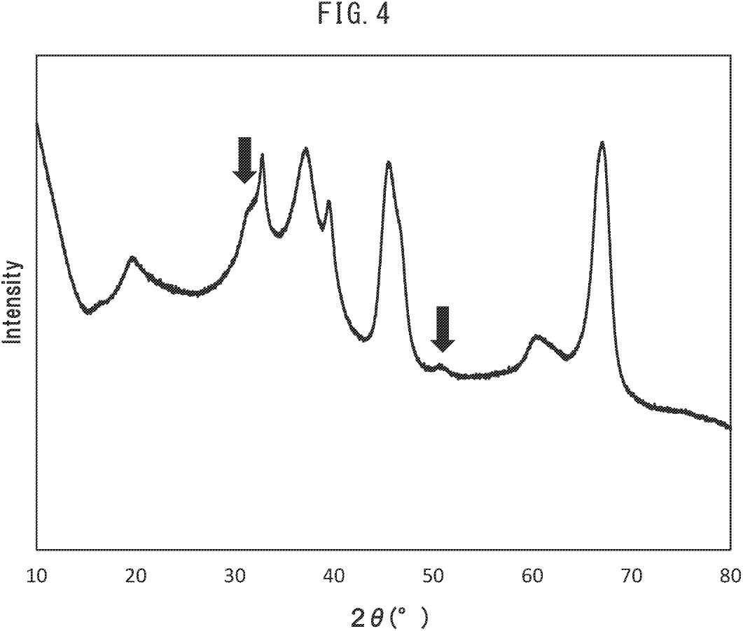

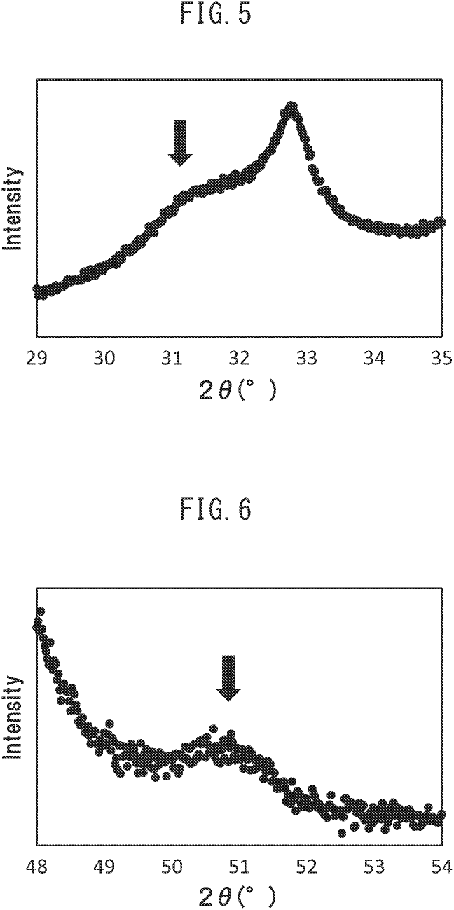

XRD charts obtained in Analysis Example 1 are shown in FIGS. 1 to 3, and XRD charts obtained in Analysis Example 2 are shown in FIGS. 4 to 6. FIGS. 1 and 4 are each a wide-area view of 2θ = 10° to 80°. FIGS. 2 and 4 are each an enlarged view in the range of 2θ = 29° to 35°, and FIGS. 3 and 6 are each an enlarged view in the range of 2θ = 48° to 54°.

In FIGS. 4 to 6 related to Analysis Example 2, the peaks attributed to Fe₂O₃ crystals are indicated by arrows.

In the XRD charts, the peaks observed in the vicinity of 2θ = 20°, 33°, 37°, 39.5°, 46°, 60°, and 67° are all considered to be attributed to γ-alumina crystals.

1-9. (canceled)

10. An exhaust gas purification catalytic device, comprising:
a substrate and one or more catalyst layers on the substrate, wherein
of the one or more catalyst layers, at least one catalyst layer comprises both
Cu-CHA zeolite particles, and
iron-supporting metal oxide particles in which iron is supported on metal oxide particles.

11. The exhaust gas purification catalytic device according to claim 10, wherein the metal oxide particles are particles of one metal oxide selected from the group consisting of alumina, silica, titania, zirconia, and ceria or a composite metal oxide of two or more selected therefrom.

12. The exhaust gas purification catalytic device according to claim 11, wherein the metal oxide particles are alumina particles.

13. The exhaust gas purification catalytic device according to claim 10, wherein an amount of iron in the exhaust gas purification catalytic device is 0.3 g/L or more and 1.3 g/L or less as a mass of iron in terms of ferric oxide (Fe₂O₃) per L of the substrate.

14. The exhaust gas purification catalytic device according to claim 11, wherein an amount of iron in the exhaust gas purification catalytic device is 0.3 g/L or more and 1.3 g/L or less as a mass of iron in terms of ferric oxide (Fe₂O₃) per L of the substrate.

15. The exhaust gas purification catalytic device according to claim 10, wherein an amount of iron in the exhaust gas purification catalytic device is 0.6 g/L or more and 1.3 g/L or less as a mass of iron in terms of ferric oxide (Fe₂O₃) per L of the substrate.

16. The exhaust gas purification catalytic device according to claim 10, wherein a ratio of the Cu-CHA zeolite particles to the iron-supporting metal oxide particles in the catalyst layer, as a mass percentage of the iron-supporting metal oxide particles with respect to a total of both particles, is 5% by mass or more and 20% by mass or less.

17. The exhaust gas purification catalytic device according to claim 11, wherein a ratio of the Cu-CHA zeolite particles to the iron-supporting metal oxide particles in the catalyst layer, as a mass percentage of the iron-supporting metal oxide particles with respect to a total of both particles, is 5% by mass or more and 20% by mass or less.

18. The exhaust gas purification catalytic device according to claim 13, wherein a ratio of the Cu-CHA zeolite particles to the iron-supporting metal oxide particles in the catalyst layer, as a mass percentage of the iron-supporting metal oxide particles with respect to a total of both particles, is 5% by mass or more and 20% by mass or less.

19. The exhaust gas purification catalytic device according to claim 10 for use in selective catalytic reduction.

20. A method for manufacturing the exhaust gas purification catalytic device according to claim 10, comprising:
(1) mixing and wet-milling the Cu-CHA zeolite particles and the iron-supporting metal oxide particles to obtain a catalyst layer forming slurry, and
(2) applying and baking the catalyst layer forming slurry on the substrate to form the catalyst layer on the substrate.

21. An exhaust gas purification method for purifying an exhaust gas using the exhaust gas purification catalytic device according to claim 19, comprising:
feeding an exhaust gas and a reductant to the exhaust gas purification catalytic device to reduce NOₓ in the exhaust gas to N₂.

22. The exhaust gas purification method according to claim 21, wherein the metal oxide particles are particles of one metal oxide selected from the group consisting of alumina, silica, titania, zirconia, and ceria or a composite metal oxide of two or more selected therefrom.

23. The exhaust gas purification method according to claim 21, wherein an amount of iron in the exhaust gas purification catalytic device is 0.3 g/L or more and 1.3 g/L or less as a mass of iron in terms of ferric oxide (Fe₂O₃) per L of the substrate.

24. The exhaust gas purification method according to claim 21, wherein a ratio of the Cu-CHA zeolite particles to the iron-supporting metal oxide particles in the catalyst layer, as a mass percentage of the iron-supporting metal oxide particles with respect to a total of both particles, is 5% by mass or more and 20% by mass or less.
